(19) United States
(12) Patent Application Publication
(10) Pub. No.: US 2025/0361577 A1
(43) Pub. Date: Nov. 27, 2025

(54) VALUABLE ELEMENT RECOVERY METHOD AND METAL PRODUCTION METHOD

(71) Applicant: JFE STEEL CORPORATION, Tokyo (JP)

(72) Inventors: Yuta HINO, Tokyo (JP); Yotaro INOUE, Tokyo (JP); Katsunori TAKAHASHI, Tokyo (JP)

(73) Assignee: JFE STEEL CORPORATION, Tokyo (JP)

(21) Appl. No.: 18/874,826

(22) PCT Filed: Jul. 19, 2023
(86) PCT No.: PCT/JP2023/026385

§ 371 Date: Dec. 13, 2024

(30) Foreign Application Priority Data
Jul. 28, 2022 (JP) 2022-120792

(51) Int. Cl. C22B 7/00; C22B 23/02; C22B 26/12; H01M 10/54

(52) U.S. Cl. CPC C22B 7/001; C22B 23/021; C22B 26/12; H01M 10/54

(57) ABSTRACT

A method for recovering a valuable element, by which method not only a valuable element but also lithium can be recovered; wherein, an oxide is reduced by adding a reductant and a flux containing CaO and SiO₂ are added to the oxide, followed by heating, the oxide containing: at least one element selected from the group consisting of nickel and cobalt; and lithium. A mass ratio between CaO and SiO₂ (CaO/SiO₂) contained in the flux is not more than 0.50.

### TECHNICAL FIELD

The present invention relates to a method for recovering a valuable element and a method for producing metal.

### BACKGROUND ART

In recent years, the demand for lithium ion batteries has been rapidly increasing due to the spread of electric vehicles.

In particular, the demand for electric vehicles with no use of fossil fuels is expected to further expand in the future from the current perspective of suppressing generation of carbon dioxide, and in association with this expectation, the demand for lithium ion batteries is also expected to further increase.

Generally, the cathode material of a lithium ion battery is made from an oxide (composite oxide) containing, for example, nickel (Ni), cobalt (Co) or manganese (Mn). Specific examples of the composite oxide include LiNiO₂, LiCoO₂ and LiMnO₂.

Metal elements such as Ni, Co and Mn are not abundantly available even on a global scale.

Therefore, it is very advantageous to recover those metal elements (valuable elements) from the cathode materials of lithium ion batteries, for the purpose of effective use of resources.

A lithium ion battery is composed of a combination of a cathode material, an anode material, a separator, and other members, and besides contains, for example, an electrolytic solution.

Hence, in order to recover valuable elements from the cathode material of a lithium ion battery, a preliminary process including removal of an electrolytic solution, pulverization, and crushing is performed prior to the recovery.

The cathode material is separated from the lithium ion battery through this preliminary process, and valuable elements are thereafter recovered from the separated cathode material.

The processes of recovering valuable elements are classified into two types, i.e., hydrometallurgical process involving dissolving the cathode material in acid, followed by solvent extraction and electrolytic refining or the like, and pyrometallurgical process involving heating the cathode material together with a reductant and a flux to generate valuable elements by reduction (e.g., Patent Literature 1).

### CITATION LIST

### Patent Literatures

Patent Literature 1: JP 2021-95628 A

Patent Literature 2: JP 2013-91826 A

Patent Literature 3: JP 2012-224877 A

### SUMMARY OF INVENTION

### Technical Problems

In the pyrometallurgical process, as a result of reducing composite oxides (LiNiO₂, LiCoO₂ and LiMnO₂), aside from metal containing valuable elements (Ni, Co and Mn), slag is formed.

Meanwhile, in addition to valuable elements such as Ni, Co and Mn, Li may also be required in some cases.

However, in the pyrometallurgical process, part of Li may be volatilized, and in this case, it is necessary to separately recover Li, which is troublesome.

The present invention has been made in view of the foregoing and aims at providing a method for recovering a valuable element, by which method not only a valuable element but also lithium can be recovered.

### Solution to Problems

The present inventors found, through an earnest study, that employing the configuration described below enables the achievement of the above-mentioned object. The invention has been thus completed.

Specifically, the present invention provides the following [1] to [9].

[1] A method for recovering a valuable element, the method comprising reducing an oxide by adding a reductant and a flux containing CaO and SiO₂ to the oxide, followed by heating, the oxide containing: at least one element selected from the group consisting of nickel and cobalt; and lithium, wherein a mass ratio between CaO and SiO₂ (CaO/SiO₂) contained in the flux is not more than 0.50.
[2] The method for recovering a valuable element according to [1], wherein a temperature for heating the oxide is not lower than 1,450° C.
[3] The method for recovering a valuable element according to [1] or [2], wherein metal containing at least one element selected from the group consisting of nickel and cobalt is obtained by reducing the oxide.
[4] The method for recovering a valuable element according to any one of [1] to [3], wherein the reductant is a carbon-containing substance containing carbon.
[5] The method for recovering a valuable element according to any one of [1] to [4], wherein the reductant is at least one iron-containing substance selected from the group consisting of metallic iron and iron oxide.
[6] The method for recovering a valuable element according to [5], wherein the iron oxide is ferrous oxide.
[7] The method for recovering a valuable element according to [5], wherein the iron-containing substance is at least one selected from the group consisting of dust, scale, sludge, and scrap.
[8] The method for recovering a valuable element according to any one of [1] to [7], wherein the oxide is obtained from a lithium ion battery.
[9] A method for producing metal containing at least one element selected from the group consisting of nickel and cobalt by using the method for recovering a valuable element according to any one of [1] to [8].

### ADVANTAGEOUS EFFECTS OF INVENTION

The present invention makes it possible to recover not only a valuable element but also lithium.

### BRIEF DESCRIPTION OF THE DRAWINGS

FIG. 1 is a graph showing a result of a reduction experiment in a case where a flux A having a mass ratio (CaO/SiO₂) of 1.50 was used.

FIG. 2 is a graph showing a result of a reduction experiment in a case where a flux B having a mass ratio (CaO/SiO₂) of 0.50 was used.

FIG. 3 is an Ellingham diagram (Gibbs standard free energy change-temperature diagram).

### DETAILED DESCRIPTION OF THE INVENTION

### Method for Recovering Valuable Element

The method for recovering a valuable element according to the invention (hereinafter, conveniently referred to as “present recovery method”) includes reducing an oxide by adding a reductant and a flux containing CaO and SiO₂ to the oxide, followed by heating, the oxide containing: at least one element selected from the group consisting of nickel and cobalt; and lithium, and a mass ratio between CaO and SiO₂ (CaO/SiO₂) contained in the flux is not more than 0.50.

Generally, the present recovery method is a method of recovering at least one element (hereinafter, also referred to as “valuable element”) selected from the group consisting of nickel (Ni) and cobalt (Co) from a cathode material (oxide) of a lithium ion battery through the pyrometallurgical process.

Further, the present recovery method is also a method of recovering lithium (Li).

### <Findings Obtained by Inventors>

A general cathode material of a lithium ion battery is made from an oxide (composite oxide) such as LiNiO₂, LiCoO₂, or LiMnO₂.

From a thermodynamic point of view, in the pyrometallurgical process, for example, LiNiO₂ and LiCoO₂ are decomposed at high temperature as expressed below, generating NiO and CoO, respectively.

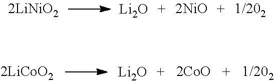

The respective Gibbs standard free energy changes (ΔG⁰) of NiO and CoO in the decomposition reaction are expressed below.

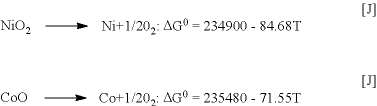

A substance having a value of the free energy change lower than the values of these Gibbs standard free energy changes at any high temperature can be used as the reductant.

When a valuable element is recovered as metal from a composite oxide by the pyrometallurgical process, a flux containing calcium oxide (CaO) and silicon dioxide (SiO₂) is used.

The mass ratio between CaO and SiO₂ (CaO/SiO₂) contained in a flux is also called basicity, and conventionally, a basicity of 0.66 to 2.00 has been said to be preferable (Patent Literatures 2 and 3).

However, the present inventors performed the reduction experiment described below and thereby found that a valuable element can be recovered as metal with high reduction ratio even when a low-basicity flux having a mass ratio (CaO/SiO₂) of not more than 0.50 is used.

In the reduction experiment, an oxide (cathode material of a lithium ion battery), i.e., the reduction target, with coke (C) as a reductant and a flux being added thereto was heated in an argon gas atmosphere at a temperature of 1,650° C., thereby forming metal and slag.

The metal thus formed is called “formed metal,” while the slag thus formed is called “formed slag.”

In the reduction experiment, as a flux, a flux A having a mass ratio (CaO/SiO₂) of 1.50 or a flux B having a mass ratio (CaO/SiO₂) of 0.50 was used.

A reduction ratio (unit: mass %) of each metal element was determined according to the following equation.

$$Reduction ratio = 100 \times ( amount of metal element contained in formed metal [ kg ] ) / ( amount of metal element contained in oxide being reduction target [ kg ] )$$

Further, a residual ratio (unit: mass %) of each metal element in the formed slag was determined according to the following equation.

$$Reduction ratio in formed slag = 100 \times ( amount of metal element contained in formed slag [ kg ] ) / ( amount of metal element contained in reduction target oxide [ kg ] )$$

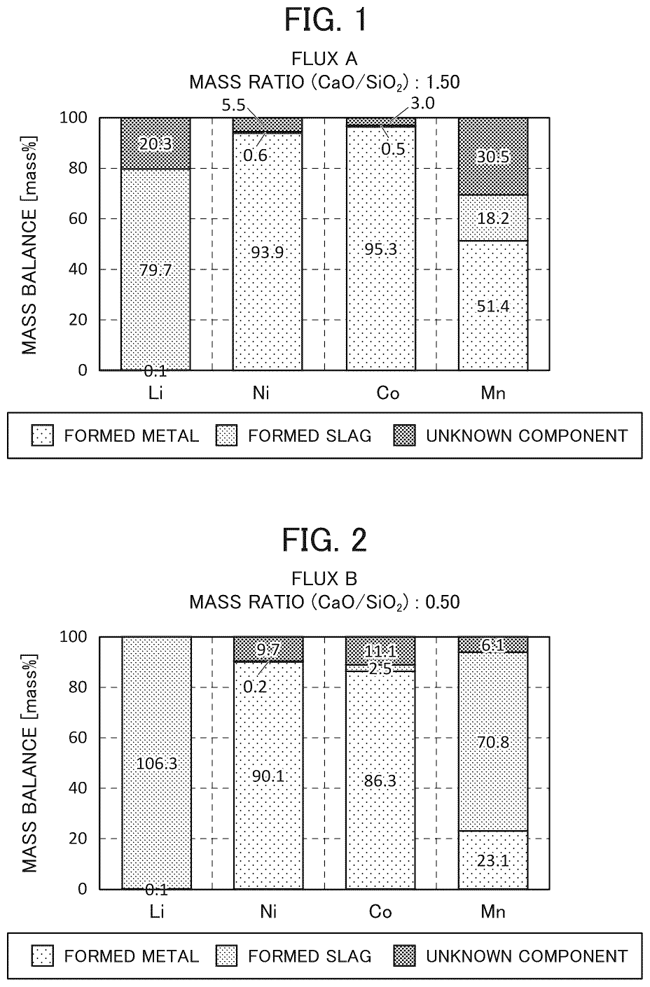

FIG. 1 is a graph showing a result of the reduction experiment in the case where the flux A having a mass ratio (CaO/SiO₂) of 1.50 was used.

FIG. 2 is a graph showing a result of the reduction experiment in a case where the flux B having a mass ratio (CaO/SiO₂) of 0.50 was used.

As shown in FIGS. 1 and 2, even when the low-basicity flux B was used, for example, Ni could achieve a high reduction ratio of more than 90 mass %.

In addition, when the low-basicity flux B was used, the reduction ratio of Mn was lower than that in the case where the high-basicity flux A was used, so that Mn was able to be retained in the slag (selective separation).

Further, in terms of Li, referring to the residual ratio in the formed slag, the residual ratio was not more than 80 mass % when the high-basicity flux A was used; on the other hand, a high value of not less than 90 mass % was exhibited when the low-basicity flux B was used.

The foregoing results revealed that when the flux having a mass ratio (CaO/SiO₂) of not more than 0.50 was used, in addition to the formed metal containing Ni and Co which are valuable elements, the formed slag containing a large amount of Li was obtained. In other words, Li was able to be recovered easily and efficiently.

The method for further recovering Li from a formed slag is not specifically limited, and examples thereof include various methods such as a method for recovering Li in the form of lithium carbonate by a hydrometallurgical process.

Next, the present recovery method is described below in more detail.

The following description also covers the method for producing metal according to the present invention.

### <Reduction Target (Oxide) >

The reduction target in the present recovery method is an oxide containing: at least one element selected from the group consisting of nickel (Ni) and cobalt (Co); and lithium (Li), and specifically is a cathode material of a lithium ion battery, for example.

This oxide may further contain manganese (Mn).

A cathode material (oxide) is obtained by performing pretreatment such as removal of an electrolyte on a lithium ion battery.

### <Reductant>

Examples of the reductant include an aluminum-containing substance such as metallic aluminum (Al); a silicon-containing substance such as metallic silicon (Si) or FeSi; a carbon-containing substance containing carbon; and an iron-containing substance.

Examples of the carbon-containing substance include a solid carbon-containing substance such as graphite, coke, or solid hydrocarbon; and a gas carbon-containing substance such as carbon monoxide (CO) or hydrocarbon gas (e.g., propane gas).

A carbon-containing substance is preferably used as a reductant because gas such as CO, CO₂ or H₂O is generated after reduction, causing no increase in an amount of formed slag.

An iron-containing substance is at least one selected from the group consisting of metallic iron (Fe) and iron oxide. The iron-containing substance as a reductant is described below in detail.

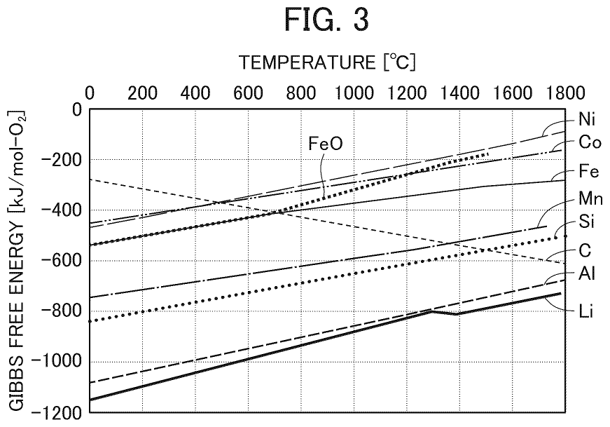

FIG. 3 is an Ellingham diagram (Gibbs standard free energy change-temperature diagram).

Referring to the Gibbs standard free energy changes described above and the Ellingham diagram (FIG. 3), the Fe/FeO equilibrium is negative as compared to the Ni/NiO equilibrium and the Co/CoO equilibrium, and it is thus expected that reduction by use of Fe may be possible.

In addition, the FeO/Fe₃O₄ equilibrium is negative as compared to the Ni/NiO equilibrium but positive as compared to the Co/CoO equilibrium.

Hence, Fe is also expected to selectively reduce Ni and Co (allowing Ni to be incorporated into a formed metal and Co to be incorporated into a formed slag). Specifically, the following reactions are expected.

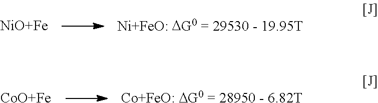

Metalization takes place more easily when the relevant line is situated at a higher position in the Ellingham diagram (FIG. 3).

When Si or Al is used as the reductant, Mn is also easily metalized.

Thus, it can be expected that by the use of Fe (or FeO) as the reductant, only Ni and Co are metalized while Mn is not metalized.

For the metallic iron (Fe), use may be made of, for example, scraps and granular iron used at an iron mill or the like.

In general, iron oxides are classified into three kinds, i.e., ferrous oxide (FeO) which may also be called Wustite, triiron tetraoxide (Fe₃O₄) which may also be called magnetite, and ferric oxide (Fe₂O₃) which may also be called hematite.

Among these, magnetite and hematite have higher Gibbs standard free energy changes than that of Wustite at the same temperature and sometimes have difficulty in causing reduction reaction.

Therefore, among iron oxides, ferrous oxide (Wustite) is preferred because it easily causes reduction reaction.

The iron oxide may be at least one of dust, scale, and sludge (hereinafter, conveniently referred to as “dusts”) that are secondarily produced in an iron making process.

Use of dusts as the iron oxide is preferred in view of effective utilization of by-products from an iron making process and utilization of an inexpensive iron source.

### <<Addition Amount of Reductant>>

The addition amount of a reductant is preferably not less than 1.0 equivalents, more preferably not less than 1.2 equivalents, and further preferably not less than 1.4 equivalents because the decrease of reduction is easily suppressed.

The upper limit of the addition amount of a reductant is not particularly limited. Meanwhile, when the addition amount of a reductant is too large, extra cost may be incurred in some cases. Hence, the addition amount of a reductant is preferably not more than 1.8 equivalents and more preferably not more than 1.6 equivalents.

The amount of a reductant required to reduce the reduction target oxide, i.e., NiO or Coo is regarded as 1.0 equivalents.

For instance, in a case where metallic iron (Fe), ferrous oxide (Fed), metallic aluminum (Al), metallic silicon (Si), coke (C) or propane (C₃H₈) is used as the reductant, reduction by use of each reductant of 1 equivalent is expressed as follows.

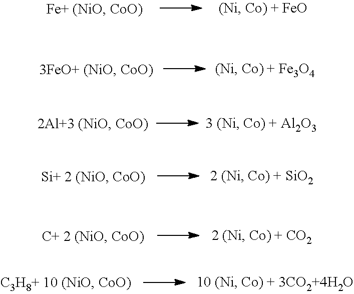

For determining the addition amount of a reductant, first, the NiO and CoO contents in an oxide, i.e., the reduction target are determined.

Specifically, the Ni and Co contents in the reduction target (oxide) are measured and are treated as the NiO and CoO contents in the reduction target (oxide).

The Ni and Co contents are measured using an energy dispersive X-ray spectrometer (EDX).

### <Flux>

As described above, in the present recovery method, a flux containing calcium oxide (CaO) and silicon dioxide (SiO₂) is used.

The content (total content) of CaO and SiO₂ in the flux is preferably not less than 90 mass %, more preferably not less than 95 mass %, further preferably not less than 98 mass %, and particularly preferably 100 mass %.

### <<Mass Ratio (CaO/SiO₂)>>

As described above, in the present recovery method, a low-basicity flux having a low mass ratio between CaO and SiO₂ (CaO/SiO₂) is used.

In other words, the mass ratio (CaO/SiO₂) of the flux used in the present recovery method is not more than 0.50, preferably not more than 0.48, more preferably not more than 0.46, further preferably not more than 0.44, particularly preferably not more than 0.42, and most preferably not more than 0.35.

On the other hand, the lower limit of the mass ratio (CaO/SiO₂) of the flux is not particularly limited and is for instance 0.15, preferably 0.20, more preferably 0.25, and further preferably 0.30.

### <<Addition Amount of Flux>>

The addition amount of a flux is not particularly limited, and the mass ratio of the flux to the reduction target oxide (flux/oxide) is preferably 0.40 to 1.00, more preferably 0.45 to 0.85, and further preferably 0.50 to 0.80.

### <Heating>

In the present recovery method, an oxide, i.e., the reduction target, with the reductant and the flux being added thereto is heated. Consequently, the oxide is reduced.

The temperature for heating the oxide (heating temperature) is preferably not lower than 1,300° C., more preferably not lower than 1,350° C., further preferably not lower than 1,400° C., and particularly preferably not lower than 1,450° C., because the decrease of reduction is easily suppressed.

The upper limit of the heating temperature is not particularly limited and is appropriately set depending on, for example, the capability of heating equipment (furnace), while a too high heating temperature may cause an excessive cost. Therefore, the heating temperature is preferably not higher than 1,800° C., and more preferably not higher than 1,700° C.

Preferred examples of the atmosphere when the oxide is heated (heating atmosphere) include: an inert atmosphere such as nitrogen gas (N₂) atmosphere, and argon gas (Ar) atmosphere; and a reducing atmosphere such as carbon monoxide gas (CO) atmosphere.

The time for heating the oxide (heating time) is preferably not less than 1 hour, more preferably not less than 2 hours, and further preferably not less than 3 hours, because the decrease of reduction is easily suppressed.

The upper limit of the heating time is not particularly limited. Meanwhile, a too long heating time may cause an excessive cost. Therefore, the heating time is preferably not more than 6 hours, and more preferably not more than 5 hours.

The equipment used for heating the oxide is not particularly limited, and examples thereof include an electric furnace, a resistance furnace, a high frequency melting furnace, a low frequency melting furnace, a rotary kiln, a vertical furnace, a steelmaking furnace, and other conventionally known equipment.

### <Formed Metal>

As a result of reducing an oxide, i.e., the reduction target, metal is formed.

In the present recovery method, metal (formed metal) obtained by reduction of the oxide contains valuable elements (Ni, Co). Thus, valuable elements (Ni, Co) contained in the reduction target oxide is recovered as the formed metal.

The formed metal may be metal containing only one valuable element among valuable elements (Ni, Co) (or, may have a higher proportion of one valuable element than that of the other valuable element).

### <Formed Slag>

As a result of reducing the oxide, i.e., the reduction target, aside from metal, slag is further formed. As described above, the slag obtained in the present recovery method (formed slag) contains a large amount of Li.

When an iron-containing substance is used as a reductant, the formed slag contains, for example, FeO.

The formed slag may also contain an oxide of a valuable element (such as MnO) that is not included in the formed metal.

In a case where an oxide containing Mn is reduced, the use of iron-containing substance as a reductant makes it possible to suppress incorporation of Mn into the formed metal obtained by the reduction because the Mn/MnO equilibrium is negative as compared to the Fe/FeO equilibrium and the FeO/Fe₃O₄ equilibrium.

When the hydrometallurgical process is performed, its treatment method largely varies depending on the form of Mn, which is troublesome. In the present recovery method adopting the pyrometallurgical process, on the other hand, Mn can be retained in formed slag, advantageously.

### EXAMPLES

The invention is specifically described below with reference to Examples. However, the invention is not limited to the examples described below.

### <Cathode Material>

First, a cathode material of a lithium ion battery was prepared.

Specifically, the lithium ion battery was subjected to preliminary process including disassembly, electric discharge, and removal of an electrolytic solution, and the cathode material was separated. The cathode material had a composition of Ni:Mn:Co=6:2:2 in molar ratio. The cathode material further contained Li.

### <Reductant>

As reductants, metallic aluminum (Al) powder, metallic silicon (Si) powder, coke (C) powder, and propane gas (C₃H₈) were prepared.

Further, as reductants, metallic iron (Fe) powder obtained through an atomization process, and ferrous oxide (FeO) powder were prepared.

### <Flux>

As a flux, a flux comprising CaO and SiO₂ was prepared. Plural types of fluxes having different mass ratios between CaO and SiO₂ (CaO/SiO₂) were prepared.

<Reduction of Cathode material: Inventive Examples 1 to 6 and Comparative Examples 1 and 2<

Next, in an electric furnace with a heat size of 150 kg, the prepared cathode material was placed, to which a reductant and a flux were added, and the resultant was heated. The cathode material was thus reduced to obtain formed metal and formed slag. The heating time was three hours, and heating atmosphere was Ar atmosphere.

The flux in an amount of 30 kg was added with respect to 45 kg of the cathode material. In other words, the mass ratio of the flux to the cathode material (flux/cathode material) was set to about 0.67.

The type of reductant used, the addition amount (unit: equivalent) of the reductant, the mass ratio (CaO/SiO₂) of the flux used, and the heating temperature (unit: ° C.) are shown in Table 1 below.

In addition, the reduction ratios of the respective metal elements, i.e., Ni, Co, and Mn were determined based on the above-described equation. The unit of the determined reduction ratio was converted from “mass %” to “mol %.”

Further, for Li, the residual ratio in the formed slag is determined according the above-described equation. The unit of the determined residual ratio in the formed slag was converted from “mass %” to “mol %.”

The results are shown in Table 1 below.

TABLE 1

| | Reductant | | | | | | | |
|---|---|---|---|---|---|---|---|---|
| | | Addition | Flux | Heating | Reduction | | | Residual ratio (Li) |
| | | amount | Mass ratio | temperature | ratio [mol %] | | | in formed slag |
| | Type | [equivalent] | (CaO/SiO₂) | [° C.] | Ni | Co | Mn | [mol %] |
| Inventive Example 1 | Al | 1.3 | 0.50 | 1430 | 90 | 85 | 11 | 89 |
| Inventive Example 2 | Si | 1.4 | 0.45 | 1600 | 93 | 94 | 14 | 98 |
| Inventive Example 3 | C | 1.5 | 0.40 | 1650 | 98 | 95 | 19 | 100 |
| Inventive Example 4 | C₃H₆ | 1.4 | 0.41 | 1660 | 94 | 91 | 18 | 100 |
| Inventive Example 5 | Fe | 1.4 | 0.50 | 1660 | 90 | 92 | 2 | 100 |
| Inventive Example 6 | FeO | 1.4 | 0.48 | 1650 | 93 | 82 | 3 | 100 |
| Inventive Example 7 | C | 1.4 | 0.30 | 1665 | 90 | 88 | 0.5 | 100 |
| Inventive Example 8 | Fe | 1.5 | 0.35 | 1680 | 90 | 85 | 0.1 | 100 |
| Comparative Example 1 | Al | 1.4 | 1.50 | 1420 | 86 | 81 | 42 | 70 |
| Comparative Example 2 | C | 1.4 | 2.50 | 1620 | 96 | 95 | 54 | 60 |

### <Summary of Evaluation Results>

As shown in Table 1 above, Inventive Examples 1 to 8 using the fluxs having a mass ratio (CaO/SiO₂) of not more than 0.50 had a higher residual ratio of Li in the formed slag than those in Comparative Examples 1 and 2 using the fluxs having a mass ratio (CaO/SiO₂) of more than 0.50.

In all of Inventive Examples 1 to 8, the reduction ratios of Ni and Co were high, while the reduction ratio of Mn was suppressed to be not more than 20%.

In particular, in Inventive Examples 5 and 6 using Fe or FeO as a reductant, the reduction ratio was more suppressed.

In Inventive Example 6, the reduction ratio of Co is lower than that in Inventive Example 5. This is probably because the free energy at the time of generating FeO is slightly lower than the free energy at the time of generating CoO (see FIG. 3). However, it is presumed that since FeO generates Fe by reduction, the reduction potential is higher than that of FeO, and comprehensively, Fe has a certain reduction potential, and the result thereof is reflected.

Comparison between Inventive Examples 1 to 6 and Inventive Examples 7 and 8 shows that in Inventive Examples 7 and 8 in which the mass ratio (CaO/SiO₂) of the flux was further lowered, the reduction ratio of Mn was able to be further suppressed without causing large decrease in reduction ratios of Ni and Co as compared with Inventive Examples 1 to 6.

1. A method for recovering a valuable element, the method comprising reducing an oxide by adding a reductant and a flux containing CaO and SiO₂ to the oxide, followed by heating,
the oxide containing: at least one element selected from the group consisting of nickel and cobalt; and lithium,
wherein a mass ratio between CaO and SiO₂ (CaO/SiO₂) contained in the flux is not more than 0.50.

2. The method for recovering a valuable element according to claim 1, wherein a temperature for heating the oxide is not lower than 1,450° C.

3. The method for recovering a valuable element according to claim 1, wherein metal containing at least one element selected from the group consisting of nickel and cobalt is obtained by reducing the oxide.

4. The method for recovering a valuable element according to claim 1, wherein the reductant is a carbon-containing substance containing carbon.

5. The method for recovering a valuable element according to claim 1, wherein the reductant is at least one iron-containing substance selected from the group consisting of metallic iron and iron oxide.

6. The method for recovering a valuable element according to claim 5, wherein the iron oxide is ferrous oxide.

7. The method for recovering a valuable element according to claim 5, wherein the iron-containing substance is at least one selected from the group consisting of dust, scale, sludge, and scrap.

8. The method for recovering a valuable element according to claim 1, wherein the oxide is obtained from a lithium ion battery.

9. A method for producing metal containing at least one element selected from the group consisting of nickel and cobalt by using the method for recovering a valuable element according to claim 1.

10. The method for recovering a valuable element according to claim 2, wherein metal containing at least one element selected from the group consisting of nickel and cobalt is obtained by reducing the oxide.

11. The method for recovering a valuable element according to claim 2, wherein the reductant is a carbon-containing substance containing carbon.

12. The method for recovering a valuable element according to claim 2, wherein the reductant is at least one iron-containing substance selected from the group consisting of metallic iron and iron oxide.

13. The method for recovering a valuable element according to claim 12, wherein the iron oxide is ferrous oxide.

14. The method for recovering a valuable element according to claim 12, wherein the iron-containing substance is at least one selected from the group consisting of dust, scale, sludge, and scrap.

15. The method for recovering a valuable element according to claim 2, wherein the oxide is obtained from a lithium ion battery.

16. A method for producing metal containing at least one element selected from the group consisting of nickel and cobalt by using the method for recovering a valuable element according to claim 2.
